(19) United States
(12) Patent Application Publication
(10) Pub. No.: US 2020/0283270 A1
(43) Pub. Date: Sep. 10, 2020

(54) ELEVATOR SYSTEM LANDING DOOR UNLOCKING MECHANISM

(71) Applicants: Frédéric BEAUCHAUD, Gien (FR); OTIS ELEVATOR COMPANY, Farmington, CT (US)

(72) Inventors: Frédéric Beauchaud, Coullons (FR); Franck Dominguez, Ouzouer sur Loire (FR)

(21) Appl. No.: 16/082,139

(22) PCT Filed: Mar. 4, 2016
(86) PCT No.: PCT/IB2016/000350

§ 371 Date: Sep. 4, 2018

(51) Int. Cl. B66B 13/16; B66B 13/12

(52) U.S. Cl. CPC B66B 13/165; B66B 5/005; B66B 13/12

(57) ABSTRACT

A landing floor door access system for an elevator system includes a door lock operably connected to a landing floor door, and a door lock controller operably connected to the door lock. The door lock controller is configured for non-contact communication with an access device such that communication between the access device and the door lock controller initiates a signal from the door lock controller to the door lock to deactivate the door lock. A method of accessing a hoistway of an elevator system, includes approaching a landing floor door of the elevator system, the landing floor door positioned at the hoistway, and initiating communication between an access device and a door lock of the landing floor door via non-contact interaction between the access device and the door lock. The door lock is deactivated via the non-contact interaction between the access device and the door lock.

### BACKGROUND

The subject matter disclosed herein relates to elevator systems. More particularly, the present disclosure relates to access restriction through landing floor doors of elevator systems.

Elevator systems typically include one or more elevator cars movable along a hoistway, with landing doors located along the hoistway to allow passengers to enter and exit the elevator cars. The landing doors are also periodically used by elevator system maintenance personnel to access the hoistway to perform service and/or maintenance on components of the elevator system, such as the machine which drives the elevator system, suspension members of the elevator car and other components.

In current elevator systems, when the maintenance personnel wish to enter the hoistway through the landing doors, they utilize shaped keys, which fit into a mechanical lock in the landing door assembly. The keys, often triangular in shape, are relatively simple and easy to replicate. As such, anyone in possession of such a key may enter the hoistway through the landing doors, whether authorized or not.

### SUMMARY

In one embodiment, a landing floor door access system for an elevator system includes a door lock operably connected to a landing floor door, and a door lock controller operably connected to the door lock. The door lock controller is configured for non-contact communication with an access device such that communication between the access device and the door lock controller initiates a signal from the door lock controller to the door lock to deactivate the door lock.

Additionally or alternatively, in this or other embodiments the access device is integrated into one of an access badge, a telecommand device, a key chain, or a near field communication (NFC) chip of a smart phone or other handheld device.

Additionally or alternatively, in this or other embodiments the access device automatically communicates with the door lock when the access device is placed within an operable range of the door lock.

Additionally or alternatively, in this or other embodiments the access device must be activated by a user before communication is initiated with the door lock.

Additionally or alternatively, in this or other embodiments the door lock is located at a lintel of the landing floor door.

In another embodiment, an elevator system includes a hoistway, an elevator car positioned in the hoistway and movable along the hoistway and a landing floor door located at the hoistway to allow access to and from the elevator car. A landing floor door access system includes a door lock operably connected to the landing floor door, and a door lock controller operably connected to the door lock. The door lock controller is configured for non-contact communication with an access device such that communication between the access device and the door lock controller initiates a signal from the door lock controller to the door lock to deactivate the door lock allowing opening of the landing floor door.

Additionally or alternatively, in this or other embodiments the access device is integrated into one of an access badge, a telecommand device, a key chain, or a near field communication (NFC) chip of a smart phone or other handheld device.

Additionally or alternatively, in this or other embodiments the access device automatically communicates with the door lock when the access device is placed within an operable range of the door lock.

Additionally or alternatively, in this or other embodiments the access device must be activated by a user before communication is initiated with the door lock.

Additionally or alternatively, in this or other embodiments the door lock is disposed at a lintel of the landing floor door.

In yet another embodiment, a method of accessing a hoistway of an elevator system includes approaching a landing floor door of the elevator system, the landing floor door positioned at the hoistway, and initiating communication between an access device and a door lock of the landing floor door via non-contact interaction between the access device and the door lock. The door lock is deactivated via the non-contact interaction between the access device and the door lock.

Additionally or alternatively, in this or other embodiments non-contact operable communication is initiated between the access device and a door lock controller to initiate a signal from the door lock controller to the door lock, and the door lock is deactivated via the signal from the door lock controller.

Additionally or alternatively, in this or other embodiments the access device is integrated into one of an access badge, a telecommand device, a key chain, or a near field communication (NFC) chip of a smart phone or other handheld device.

Additionally or alternatively, in this or other embodiments the method includes automatically communicating with the door lock via the access device when the access device is placed within an operable range of the door lock.

Additionally or alternatively, in this or other embodiments the method includes activating the access device before communication is initiated with the door lock.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic view of an embodiment of an elevator system; and

FIG. 2 is a schematic view of an embodiment of a landing door access system for an elevator system.

### DETAILED DESCRIPTION

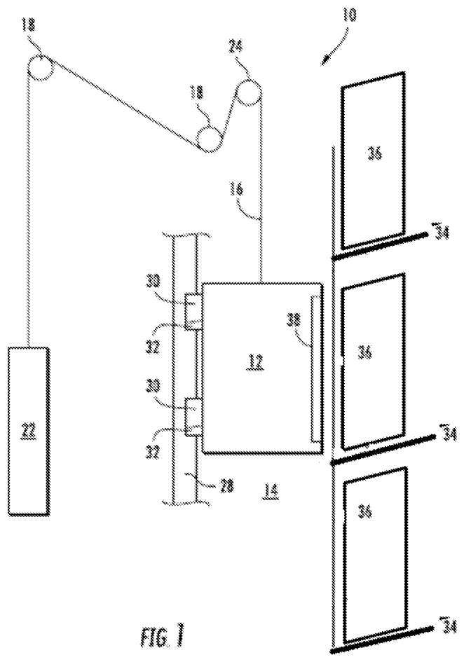

Shown in FIG. 1 is a schematic of an exemplary traction elevator system 10. The elevator system 10 includes an elevator car 12 operatively suspended or supported in a hoistway 14 with one or more suspension members 16, such as ropes or belts. The one or more suspension members 16 interact with one or more sheaves 18 to be routed around various components of the elevator system 10. The one or more sheaves 18 could also be connected to a counterweight 22, which is used to help balance the elevator system 10 and reduce the difference in suspension member 16 tension on both sides of a traction sheave 24 during operation.

The elevator system 10 further includes one or more guide rails 28 to guide the elevator car 12 along the hoistway 14. The elevator car 12 includes one or more guide shoes or rollers 30 interactive with the guide rails 28 to guide the elevator car 12. The elevator car 12 also may include safeties 32 interactive with the guide rail 28 to slow and/or stop motion of the elevator car 12 under certain conditions, such as an overspeed condition.

The hoistway 14 includes one or more landing floors 34 at which the elevator car 12 stops to allow ingress and/or egress of passengers from the elevator car 12 through elevator car doors 38. A landing floor door 36 is located at each landing floor 34 of the hoistway 14. During elevator system operation, the landing floor door 36 opens when the elevator car 12 is present at the landing floor 34 to allow for passenger ingress and/or egress. The landing floor door 36 is also utilized as an access point for service personnel to access the elevator car 12 and/or an interior of the hoistway 14 to perform inspections, service, maintenance, repairs or other tasks related to the elevator car 12 or other components of the elevator system 10 located in the hoistway 14, such as the suspension members 16, sheaves 18, guide rails 28, counterweight 22, or other components.

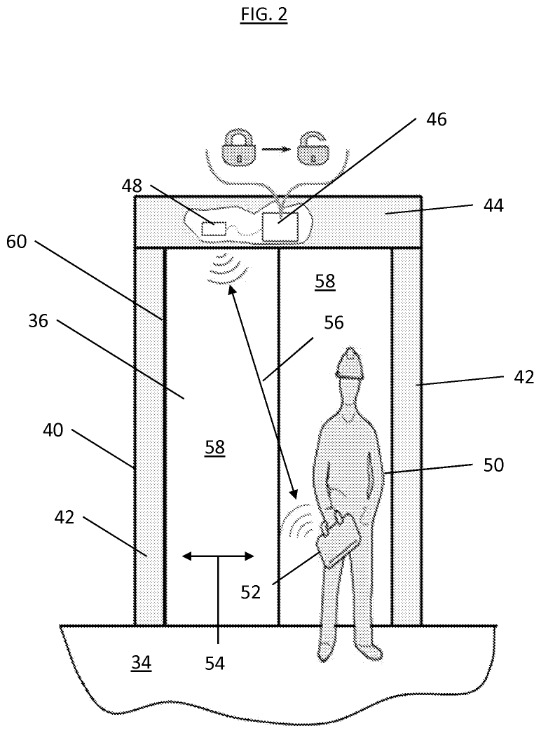

Referring to FIG. 2, the landing floor door 36 may comprise a pair of landing floor door panels 58 located at a door opening 60. The landing floor door panels 58 meet at a center of the door opening 60 and open laterally outwardly from the center of the door opening 60, or alternatively from a side of the door opening 60. The door opening 60 is bounded by a door frame 40 including vertical frame sides 42 and a door lintel 44 spanning between the frame sides 42. A door lock 46 is located at the door frame 40, in some embodiments at the door lintel 44. When the door lock 46 is activated, the landing floor door 36 cannot be opened, and when the door lock 46 is deactivated, the landing floor door 36 may be opened, either manually or through operation of the elevator car doors, interactive with the landing floor door 36.

The door lock 46 may be, for example, a mechanical lock, magnetic lock or electrical lock, and is operably connected to a door lock controller 48. A connection between the door lock 46 and the door lock controller 48 may be an electrical wire or may be a wireless connection. The door lock controller 48 may be located at any suitable location, such as the door lintel 44 or one of the frame sides 42. A technician 50, who may be seeking access to the hoistway 14 via the landing floor door 36 is provided with an access device 52, which may be passive, and integrated into an access badge, key chain, or near field communication chip (NFC) of a smartphone, or may be an active access device 52 such as a telecommand device, a push-button remote control device or the like. In some embodiments, communication between the access device 52 and the door lock controller 48 is via radio frequency identification (RFID). In some embodiments, the access device 52 is passive, meaning that no action by the technician 50, other than placing the access device 52 within communication range of the door lock controller 48, is necessary to initiate communication between the access device 52 and the door lock controller 48. Examples of passive access devices 52 include, but are not limited to, such a device integrated into an access badge, key chain, or near field communication chip (NFC) of a smartphone. In other embodiments, the access device 52 may be active and require activation by the technician 50 to communicate with the door lock controller 48. For example, the transmitter 52 may require a button push or entry of a code into the access device 52 before initiating communication with the door lock controller 48. Examples of active access devices 52 include, but are not limited to, a telecommand device such as a push-button remote control device or the like. Further, the access device 52/door lock controller 48 communication is non-contact. No physical contact between the access device 52 and the door lock controller 46 or other components such as the door lock 46 or the landing floor door 36 is necessary to deactivate the door lock 46.

When the access device 52 communicates with the door lock controller 48, the door lock controller 48 transmits a signal to the door lock 46 to deactivate the door lock 46, allowing the technician 50 to open the landing floor door 36 by, for example, pushing the landing floor door 36 from a closed position (shown in FIG. 2) to an opened position in the direction of arrows 54. The access device 52 has an operational range 56, in some embodiments, about 6 feet or 2 meters so that the access device 52 must be located in close proximity to the door lock controller 48 to receive the signal from the access device 52. This prevents inadvertent or unintentional deactivation of the door lock 46, such as in elevator system 10 installations with multiple hoistways 14 and multiple sets of landing floor doors 36 at a landing floor 34.

In some embodiments, the same access device 52 may be similarly utilized to allow the technician 50 to access maintenance panels (not shown) or other components inside the elevator car 12 and/or inside the hoistway 14. The contactless device disclosed herein to unlock the landing floor door 36 allowing technician access to the elevator car 12 and/or hoistway 14 reduces unauthorized access through the landing floor door 36 by eliminating the conventional mechanical key and lock arrangement at the landing floor door 36. The reduction in unauthorized access in turn enhances safety of elevator system 10 passengers and technicians.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A landing floor door access system for an elevator system comprising:
a door lock operably connected to a landing floor door; and
a door lock controller operably connected to the door lock, the door lock controller configured for non-contact communication with an access device such that communication between the access device and the door lock controller initiates a signal from the door lock controller to the door lock to deactivate the door lock.

2. The landing floor door access system of claim 1, wherein the access device is integrated into one of an access badge, a telecommand device, a key chain, or a near field communication (NFC) chip of a smart phone or other handheld device.

3. The landing floor door access system of claim 1, wherein the access device automatically communicates with the door lock when the access device is placed within an operable range of the door lock.

4. The landing floor door access system of claim 1, wherein the access device must be activated by a user before communication is initiated with the door lock.

5. The landing floor door access system of claim 1, wherein the door lock is disposed at a lintel of the landing floor door.

6. An elevator system, comprising:
a hoistway;
an elevator car disposed in the hoistway and movable along the hoistway;
a landing floor door disposed at the hoistway to allow access to and from the elevator car; and
a landing floor door access system including:
a door lock operably connected to the landing floor door; and
a door lock controller operably connected to the door lock, the door lock controller configured for non-contact communication with an access device such that communication between the access device and the door lock controller initiates a signal from the door lock controller to the door lock to deactivate the door lock allowing opening of the landing floor door.

7. The elevator system of claim 6, wherein the access device is integrated into one of an access badge, a telecommand device, a key chain, or a near field communication (NFC) chip of a smart phone or other handheld device.

8. The elevator system of claim 6, wherein the access device automatically communicates with the door lock when the access device is placed within an operable range of the door lock.

9. The elevator system of claim 6, wherein the access device must be activated by a user before communication is initiated with the door lock.

10. The elevator system of claim 6, wherein the door lock is disposed at a lintel of the landing floor door.

11. A method of accessing a hoistway of an elevator system, comprising:
approaching a landing floor door of the elevator system, the landing floor door disposed at the hoistway;
initiating communication between an access device and a door lock of the landing floor door via non-contact interaction between the access device and the door lock; and
deactivating the door lock via the non-contact interaction between the access device and the door lock.

12. The method of claim 11, further comprising:
initiating non-contact operable communication between the access device and a door lock controller to initiate a signal from the door lock controller to the door lock; and
deactivating the door lock via the signal from the door lock controller.

13. The method of claim 11 wherein the access device is integrated into one of an access badge, a telecommand device, a key chain, or a near field communication (NFC) chip of a smart phone or other handheld device.

14. The method of claim 11, further comprising automatically communicating with the door lock via the access device when the access device is placed within an operable range of the door lock.

15. The method of claim 11 further comprising activating the access device before communication is initiated with the door lock.
